(19) United States
(12) Patent Application Publication
(10) Pub. No.: US 2026/0303290 A1
(43) Pub. Date: Oct. 1, 2026

(54) PATH LOSS REFERENCE SIGNAL (PLRS) IDENTIFIER UPDATE FOR A CONFIGURED GRANT (CG)

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/480,716

(22) PCT Filed: May 11, 2023
(86) PCT No.: PCT/CN2023/093420

§ 371 Date: Oct. 31, 2025

(51) Int. Cl. H04L 5/00; H04W 72/1268; H04W 72/231

(52) U.S. Cl. CPC H04L 5/0051; H04W 72/1268; H04W 72/231

(57) ABSTRACT

Certain aspects of the present disclosure provide a method for wireless communications at a user equipment (UE). The UE may receive radio resource control (RRC) signaling that configures the UE with a configured grant (CG) of periodic transmission occasions, activates the CG, and indicates a path loss reference signal (PLRS) identifier associated with the CG. The UE may further receive a medium access control (MAC) control element (CE) indicating an updated PLRS identifier associated with the CG. The UE transmits an uplink transmission in a transmission occasion of the CG, with transmission power determined in accordance with the updated PLRS identifier.

### BACKGROUND

### Field of the Disclosure

Aspects of the present disclosure relate to wireless communications, and more particularly, to techniques for updating a path loss reference signal (PLRS) identifier associated with a configured grant (CG).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving first signaling that configures the UE with a configured grant (CG) of periodic transmission occasions, activates the CG, and indicates a path loss reference signal (PLRS) identifier associated with the CG; receiving second signaling indicating an updated PLRS identifier associated with the CG; and transmitting an uplink transmission in a transmission occasion of the CG, with transmission power determined in accordance with the updated PLRS identifier.

Another aspect provides a method for wireless communications by a network entity. The method includes transmitting first signaling configuring a UE with a CG of periodic transmission occasions, activating the CG, and indicating a PLRS identifier associated with the CG; transmitting second signaling indicating an updated PLRS identifier associated with the CG; and receiving an uplink transmission in a transmission occasion of the CG, with transmission power determined in accordance with the updated PLRS identifier.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example medium access control (MAC) layer message.

FIGS. 6A-6D depict call flow diagrams illustrating example communication among a UE and a network entity.

FIG. 7 depicts a method for wireless communications at a UE.

FIG. 8 depicts a method for wireless communications at a network entity.

FIGS. 9-10 depict aspects of example communications devices.

### DETAILED DESCRIPTION

Configured scheduling is a mechanism in which a network entity can schedule physical uplink shared channel (PUSCH) transmissions without using downlink control information (DCI) for every transmission. The configured scheduling mechanism for uplink is referred to as a configured grant (CG).

There are generally two types of CG configurations, referred to as type 1 CG and type 2 CG. For type 1 CG, an uplink grant configuration is provided by radio resource control (RRC) signaling as well as activation/deactivation of the CG. For example, the network entity sends the RRC signaling to a user equipment (UE) configuring all parameters necessary for PUSCH scheduling. The UE may process the RRC and then transmit a PUSCH without any specific lower layer trigger (i.e., DCI trigger).

For a type 1 CG PUSCH, the UE may also be configured (e.g., using the RRC signaling) with a path loss (PL) reference signal (RS) identifier corresponding to a PUSCH power control identifier/sounding reference signal (SRS) identifier. For example, the UE may transmit the PUSCH with transmission power determined in accordance with measurement of PLRS indicated by the PLRS identifier. Currently, the PLRS identifier for the type 1 CG PUSCH is only updated via RRC signaling. Unfortunately, the RRC signaling is relatively slow and by the time the PLRS is updated via the RRC signaling, channel conditions may have (again) changed.

Aspects of the present disclosure provide apparatuses, methods, processing systems, and computer-readable mediums for medium access control (MAC) layer update or reconfiguration of the PLRS identifier for the type 1 CG PUSCH. For example, some techniques described herein provide signaling for PLRS identifier update or reconfiguration, via a MAC control element (CE), which may result in a much faster update than the RRC signaling.

Particular aspects of the subject matter described in this disclosure can be implemented to realize one or more of the following potential advantages. In some examples, flexibility to update configuration of the PLRS identifier may be improved and latency may be reduced (e.g., by using the MAC-CE rather than the RRC signaling). In other examples, more accurate transmission power control for the type 1 CG PUSCH may be achieved, since the UE is able to transmit the PUSCH with the transmission power based on current channel conditions.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

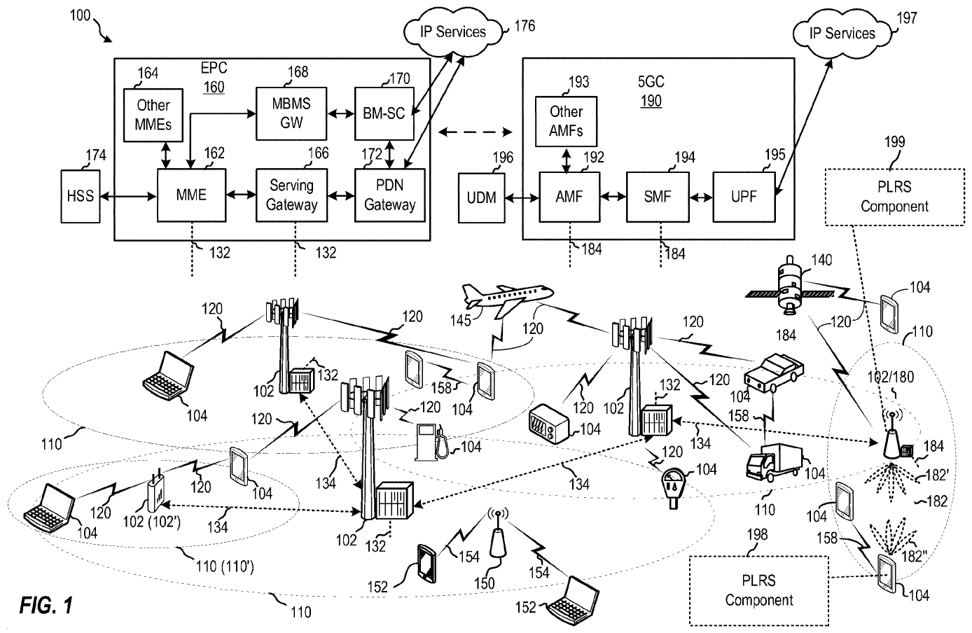

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

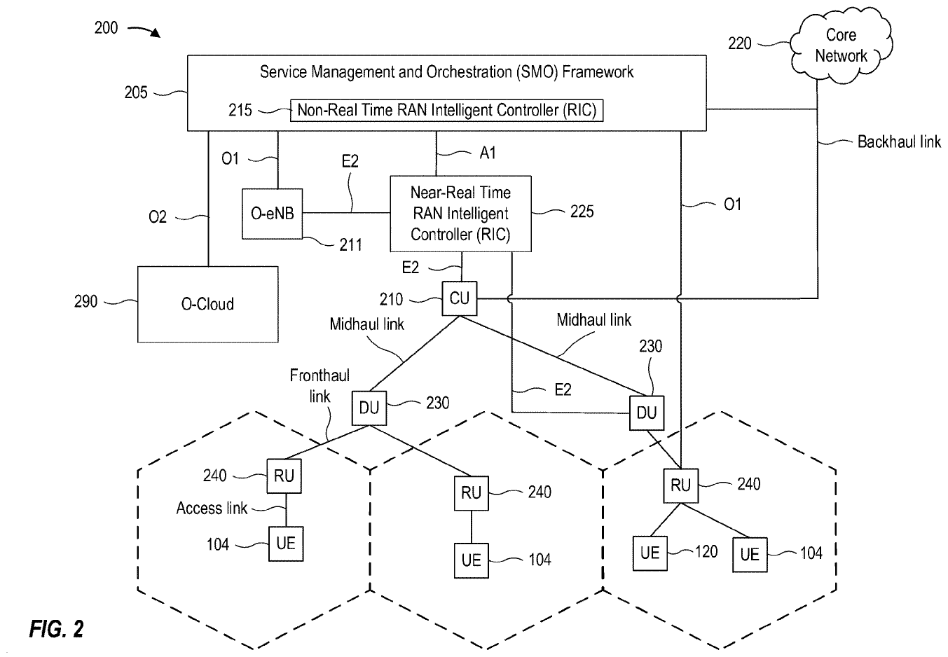

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR 1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mm Wave radio frequency bands (e.g., a mm Wave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

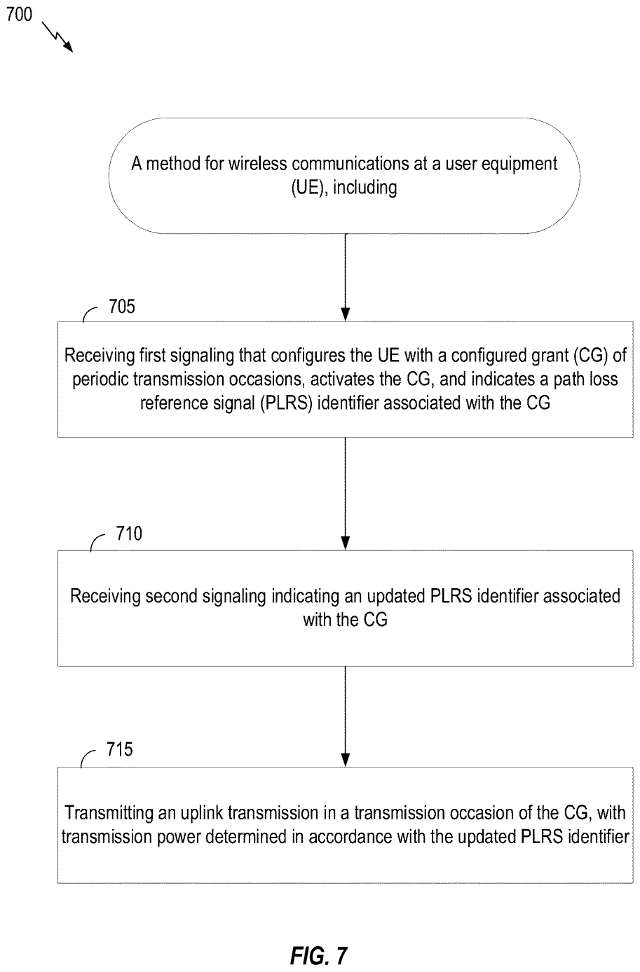

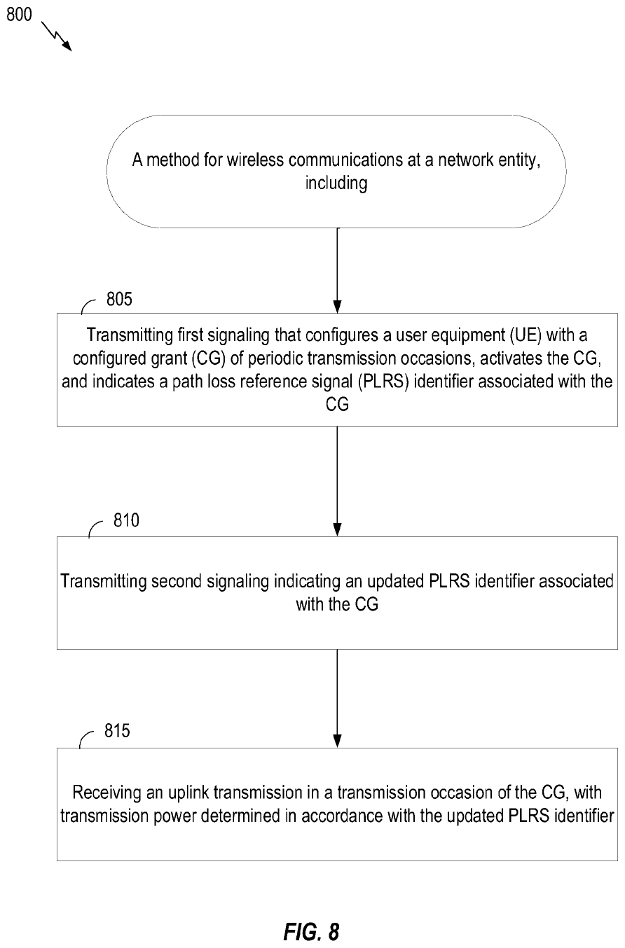

Wireless communication network 100 further includes path loss reference signal (PLRS) component 198, which may be configured to perform method 700 of FIG. 7. Wireless communication network 100 further includes PLRS component 199, which may be configured to perform method 800 of FIG. 8.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

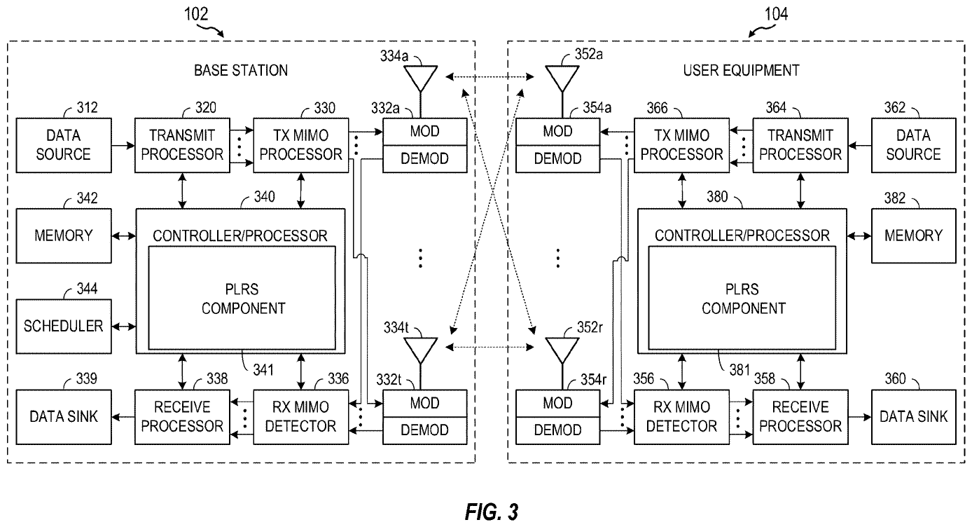

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes PLRS component 341, which may be representative of PLRS component 199 of FIG. 1. Notably, while depicted as an aspect of controller/processor 340, PLRS component 341 may be implemented additionally or alternatively in various other aspects of BS 102 in other implementations.

Generally, UE 104 includes various processors (e.g., 358, 364, 366, and 380), antennas 352 a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes PLRS component 381, which may be representative of PLRS component 198 of FIG. 1. Notably, while depicted as an aspect of controller/processor 380, PLRS component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

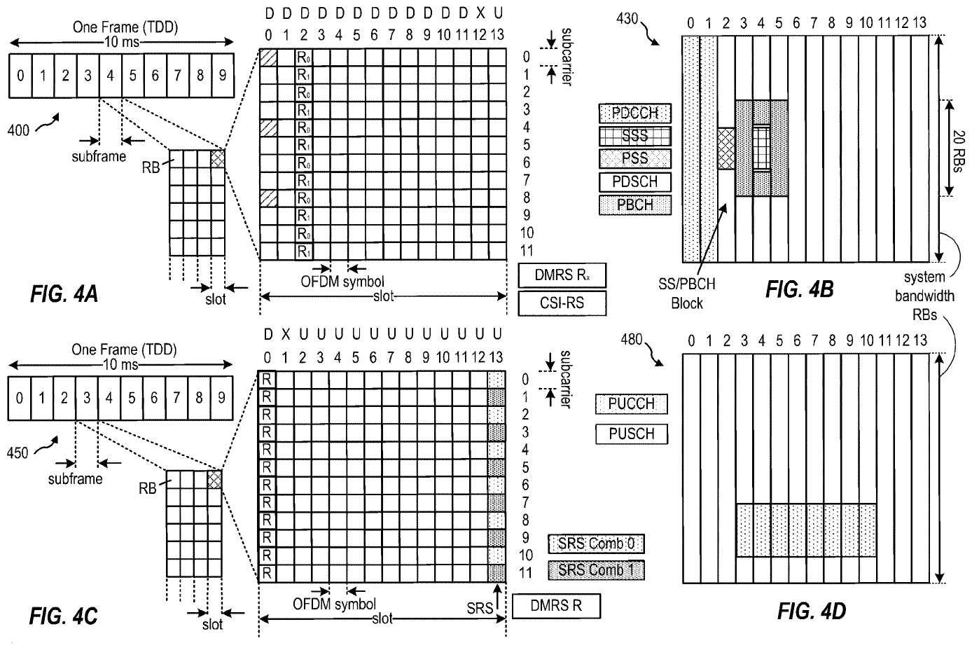

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Introduction to Configured Scheduling

Configured scheduling is a mechanism in which a network entity can schedule physical downlink shared channel (PDSCH) and/or physical uplink shared channel (PUSCH) transmissions without using downlink control information (DCI) for every transmission. The configured scheduling mechanism for downlink is called a semi-persistent scheduling (SPS). The configured scheduling mechanism for uplink is called a configured grant (CG).

SPS resource allocation, which is sometimes called configured downlink assignment, refers to a scheduling technique where a user equipment (UE) is pre-configured by a network entity with a periodicity of configured downlink assignments. For example, the network entity may pre-configure SPS occasions, which may repeat according to the pre-configured periodicity, resulting in periodic SPS occasions. For the SPS, the network entity may use radio resource control (RRC) signaling to define the periodicity of the configured downlink assignments. Similarly, the network entity may also pre-configure CG occasions, which may repeat according to a pre-configured periodicity, resulting in periodic CG occasions.

The term occasion may refer to a time in which resources are allocated for a transmission that may or may not ultimately happen. For example, a downlink transmission may or may not occur in the SPS occasions. Similarly, an uplink transmission may or may not occur in the CG occasions. The occasions may be considered activated if the transmission may occur and, thus, those occasions should be monitored.

There are generally two types of CG configurations, referred to as type 1 CG and type 2 CG.

For the type 1 CG, an uplink grant configuration is provided by the RRC signaling as well as activation/deactivation of the CG. For example, the network entity sends the RRC signaling to the UE configuring all the parameters necessary for PUSCH scheduling. The UE may process the RRC and then transmit a PUSCH without any specific lower layer trigger (i.e., DCI trigger).

For the type 2 CG, the uplink grant configuration is provided to the UE via the RRC signaling and its activation/deactivation is provided via a physical downlink control channel (PDCCH) grant (e.g., via the DCI). For example, the network entity sends the RRC signaling to the UE configuring all the parameters necessary for the PUSCH scheduling. When the network entity may want to start granting (scheduling) the PUSCH, the network entity sends the DCI to the UE. The UE may process the DCI and then transmit the PUSCH as scheduled in the RRC.

### Introduction to Path Loss (PL) Measurement

A user equipment (UE) performs a path loss (PL) measurement to determine a PL value for a channel between the UE and a network entity. For example, the UE may perform the PL measurement for the purpose of power control and beam measurement of an uplink transmission, such as a physical uplink shared channel (PUSCH), a physical uplink control channel (PUCCH), etc.

The UE performs the PL measurements using a PL reference signal (RS). The PLRS may be mapped to a synchronization signal block (SSB) index or a channel state information (CSI) RS resource index by reference to a PL reference RS identifier of the PLRS. For example, the UE may be configured (e.g., via radio resource control (RRC) signaling) with one or more configurations for the PL reference RS identifier that map to different SSB indexes or CSI-RS resource indexes. Furthermore, the UE may be configured with one or more mappings between PL reference RS identifiers (that are mapped to different SSB indexes or CSI-RS indexes) and corresponding PUSCH power control identifiers or sounding reference signal (SRS) resource set identifiers. The PUSCH power control identifier may be used when the UE is to perform PUSCH power control or beam measurement. The SRS resource set identifier may be used when the UE is to perform SRS power control or beam management.

The UE may receive downlink control information (DCI) that includes an SRS resource indicator field that indicates a PUSCH power control identifier or an SRS resource set identifier, and may use a CSI-RS or SSB index that corresponds to the PL reference RS identifier mapped to the PUSCH power control identifier or the SRS resource set identifier that was indicated by the DCI. This may be referred to as activating the mapping or updating the mapping. For example, the DCI may indicate a PUSCH power control identifier or an SRS resource set identifier (depending on which type of power control the UE is to perform), the UE may determine a PL reference RS index mapped to the PUSCH power control identifier or the SRS resource set identifier, and then the UE may identify an RS to be used as the PLRS based at least in part on which RS (of the CSI-RS and the SSB) is configured as associated with the PL reference RS index.

### Introduction to Medium Access Control (MAC) Control Element (CE) Based Path Loss Reference Signal (PLRS) Identifier Update for Type-2 Configured Grant (CG)

For a type 2 configured grant (CG) physical uplink shared channel (PUSCH), a medium access control (MAC)-layer message may be used to update a path loss (PL) reference signal (RS) identifier corresponding to the type 2 CG PUSCH.

Initially, a network entity may provide configuration information to a user equipment (UE). The configuration information includes radio resource control (RRC) signaling. The configuration information may identify a mapping between a PL reference RS identifier (or a set of PL reference RS identifiers) and an RS, such as a synchronization signal block (SSB) identified by an SSB index, a channel state information (CSI)-RS identified by a CSI-RS index, and/or the like.

In some cases, when the PL reference RS identifier is to be used for PUSCH power control, the PL reference RS identifier may be a value of a parameter (e.g., “PUSCH-Path lossReferenceRS-ID”). In some cases, when the PL reference RS identifier is to be used for sounding reference signal (SRS) power control, the PL reference RS identifier may be a value of a parameter (e.g., “path lossReferenceRS”). In some cases, the PL reference RS identifier may be referred to as a PLRS identifier.

The network entity may also provide the MAC-layer message to the UE. The MAC-layer message includes a MAC control element (CE). The MAC-layer message may identify a set of mappings between a set of PL reference RS identifiers and a set of PUSCH power control identifiers (e.g., in a one-to-one configuration, a many-to-one configuration, or a one-to-many configuration). In one example, the MAC-layer message may identify the set of mappings between the set of PL reference RS identifiers and a set of SRS resource set/SRS identifiers.

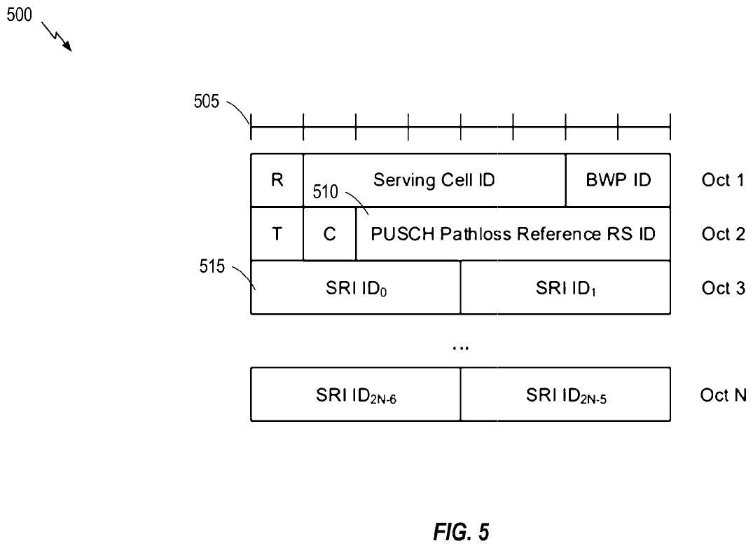

Examples of a message structure for the MAC-layer message used to provide mappings between one or more PL reference RS identifiers and one or more SRS identifiers is shown in a diagram 500 of FIG. 5. For example, the FIG. 5 shows an example of explicit indication of the mapping between a PL reference RS identifier (shown as PUSCH Path loss Reference RS ID) and at least one SRS identifier (shown as SRS resource indicator (SRI) ID).

In the FIG. 5, a horizontal axis shown, for example, by a reference number 505 indicates bit columns. For example, the rightmost column in the FIG. 5 may represent a first bit of respective Octets 1 through N (shown as October (Oct) 1 through Oct N at the right side of FIG. 5) and so on.

In the diagram 500, the MAC-layer message may explicitly identify a PL reference RS identifier and a corresponding set of SRS identifiers (shown as SRS ID₀, SRS ID₁). For example, the MAC-layer message includes a PUSCH Path loss Reference RS ID field 510. The PUSCH Path loss Reference RS ID field indicates a PUSCH PL Reference RS ID, which is to be updated in an SRI PUSCH power control mappings indicated by SRI ID fields 515 indicated in a same MAC-CE. The length of the PUSCH Path loss Reference RS ID field may be 6 bits.

The MAC-layer message further includes at least one SRI ID field. The SRI ID field indicates an SRI PUSCH power control ID. The length of the SRI ID field is 4 bits.

The MAC-layer message further includes a serving cell ID field. The serving cell ID field indicates an identity of a serving cell, which contains activated PUSCH PL reference RS. The length of the serving cell ID field is 5 bits.

The MAC-layer message further includes a bandwidth part (BWP) ID field. The BWP ID field indicates an uplink BWP as a codepoint of a downlink control information (DCI) BWP ID field, which contains activated PUSCH PL reference RS. The length of the BWP ID field is 2 bits.

The MAC-layer message further includes T field. If the UE is configured with two SRS resources sets for codebook or non-codebook in the indicated BWP of the indicated serving cell, if this field is set to 0, SRI ID(s) to be updated are the ones associated with a first SRS resource set, and if this field is set to 1 the SRI ID(s) to be updated are the ones associated with a second SRS resource set. Otherwise, this field is a reserved bit set to 0.

The MAC-layer message further includes C field. The C field indicates a presence of an additional SRI ID in a last octet of the MAC CE. If this field is set to 1, two SRI ID(s) are present in the last octet. Otherwise only one SRI ID (i.e. a first SRI ID) is present in the last octet.

The MAC-layer message further includes a reserved (R) field. The R field indicates a reserved bit, which may be set to 0.

### Aspects Related to Path Loss Reference Signal (PLRS) Update for a Type-1 Configured Grant (CG) Configuration

For a type 1 configured grant (CG) physical uplink shared channel (PUSCH), a user equipment (UE) is configured (e.g., using radio resource control (RRC) signaling) with a path loss (PL) reference signal (RS) identifier corresponding to a physical uplink shared channel (PUSCH) power control identifier/sounding reference signal (SRS) identifier. For example, the UE may transmit a PUSCH with transmission power determined in accordance with measurement of PLRS indicated by the PLRS identifier. In certain systems, the PLRS identifier for the type 1 CG PUSCH is only updated via RRC signaling. Unfortunately, the RRC signaling is relatively slow and by the time the PLRS is updated via the RRC signaling, channel conditions may have (again) changed.

Aspects of the present disclosure provide apparatuses, methods, processing systems, and computer-readable mediums for medium access control (MAC) layer update or reconfiguration of the PLRS identifier for the type 1 CG PUSCH. For example, some techniques described herein provide signaling for PLRS identifier update or reconfiguration, via a MAC control element (CE), which may result in a much faster update than the RRC signaling.

Particular aspects of the subject matter described in this disclosure can be implemented to realize one or more of the following potential advantages. In some examples, flexibility to update configuration of the PLRS identifier may be improved and latency may be reduced (e.g., by using the MAC-CE rather than the RRC signaling). In other examples, more accurate transmission power control for the type 1 CG PUSCH may be achieved, since the UE is able to transmit the PUSCH with the transmission power based on current operating conditions of the UE.

Particular aspects of the subject matter described in this disclosure can be implemented to realize one or more of the following potential advantages. In some examples, flexibility to update configuration of the PLRS identifier may be improved and latency may be reduced (e.g., by using the MAC-layer message rather than the RRC signaling), thereby reducing computing resource usage. In other examples, transmission power control for the type 1 CG PUSCH may be improved, since the UE is able to transmit the PUSCH with the transmission power based on the current channel conditions.

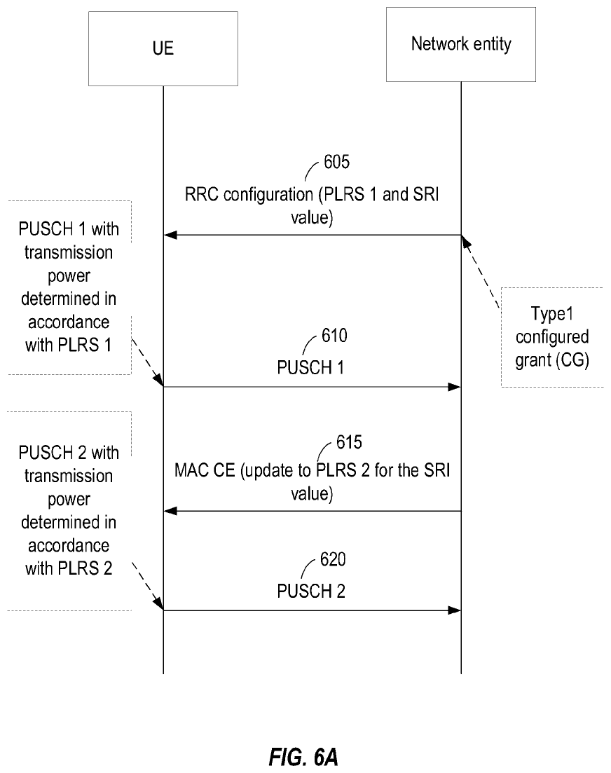

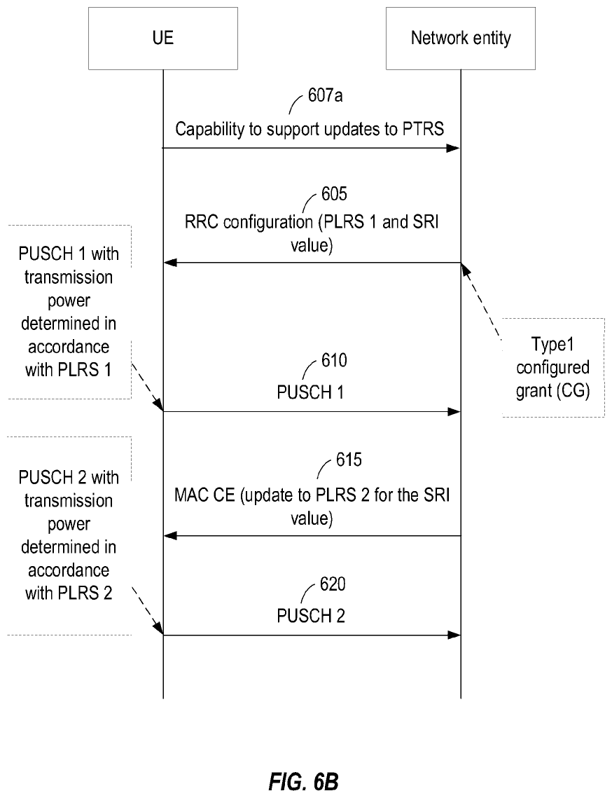

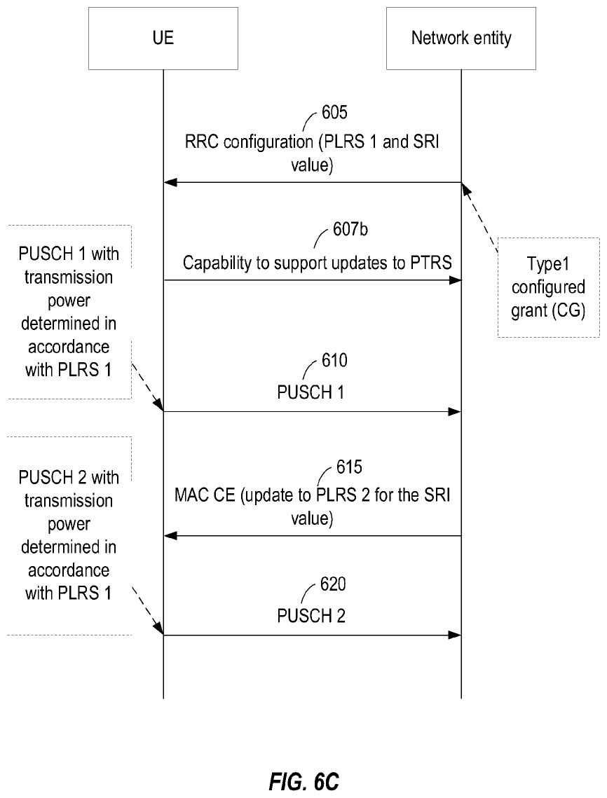

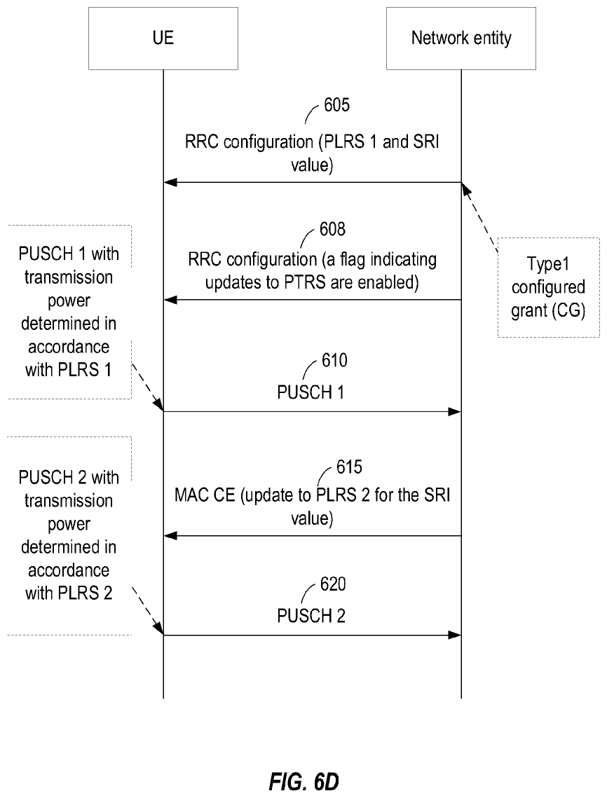

The techniques proposed herein may be understood with reference to FIGS. 6A-10.

FIGS. 6A-6D depict call flow diagrams illustrating example communication among a UE and a network entity for PLRS updates, in accordance with aspects of the present disclosure. The network entity shown in the FIGS. 6A-6D may be an example of the BS 102 depicted and described with respect to FIGS. 1 and 3 or a disaggregated BS depicted and described with respect to FIG. 2. The UE shown in the FIGS. 6A-6D may be an example of UE 104 depicted and described with respect to FIGS. 1 and 3.

As depicted in FIG. 6A, at 605, the UE receives an RRC configuration from the network entity that configures the UE with a type 1 CG and indicates a first PLRS identifier (e.g., PLRS 1) associated with the type 1 CG. In some cases, the first PLRS identifier is corresponding to an SRS resource indicator (SRI) value.

At 610, the UE transmits a first PUSCH (e.g., PUSCH 1 with transmission power determined in accordance with the first PLRS identifier) to the network entity.

At 615, the network entity transmits a MAC control element (CE) indicating an updated first PLRS identifier (e.g., a second PLRS identifier PLRS 2) associated with the type 1 CG. In some cases, the updated first PLRS identifier is corresponding to the SRI value.

At 620, the UE transmits a second PUSCH (e.g., PUSCH 2 with transmission power determined in accordance with the second PLRS identifier) to the network entity.

In certain aspects, the UE reports a capability of the UE to support updates to a PLRS identifier (e.g., the PLRS 1) associated with the type 1 CG. In one example, as depicted in FIG. 6B, at 607a, the UE transmits an indication of the capability of the UE to support the updates to the PLRS identifier associated with the type 1 CG. In this example, the UE transmits the indication prior to receiving the RRC configuration (at 605). In another example case, as depicted in FIG. 6C, at 607b, the UE transmits the indication of the capability of the UE to support the updates to the PLRS identifier associated with the type 1 CG, after receiving the RRC configuration (at 605).

For example, for the UE that reports the capability (e.g., to support the updates to the PLRS identifier) and is configured with a CG PUSCH (e.g., the type 1 CG) via the RRC configuration (e.g., “ConfiguredGrantConfig”), if an RRC-configured CG (e.g., “rrc-ConfiguredUplinkGrant”) with the first SRI value (e.g., “a srs-ResourceIndicator value) is included in the RRC configuration and the UE is enabled for the updates to the PLRS identifier (e.g., “enablePL-RS-UpdateForPUSCH-SRS”), when the MAC-CE updates the first PLRS identifier (e.g., for an SRI PUSCH power control ID which is identified by an identifier (e.g., “sri-PUSCH-PowerControlId”)) and associated with an SRI value for an uplink downlink control information (DCI)) identical to the first SRI value, the UE may apply the updated first PLRS identifier for the CG PUSCH.

In certain aspects, the RRC configuration also indicates that updates to the PLRS identifier associated with the CG are enabled. For example, the RRC configuration may include a flag to indicate that the updates to the PLRS identifier associated with the CG are enabled. For example, for the UE configured with the CG PUSCH via the RRC configuration, if the RRC-configured CG with the first SRI value is included in the RRC configuration, the flag (e.g., for PLRS update) is included in the RRC configuration, and the UE is enabled for the updates to the PLRS identifier, when the MAC-CE updates the first PLRS identifier, the UE may apply the updated first PLRS identifier for the CG PUSCH.

In certain aspects, the UE may receive another RRC configuration to indicate that the updates to the PLRS identifier for different CGs (e.g., the type 1 CG PUSCH and a type 2 CG PUSCH) are enabled. For example, as depicted in FIG. 6D, at 608, the UE receives another RRC configuration including a flag to indicate that the updates to the PLRS identifier for the CGs are enabled. For example, for the UE configured with the CG PUSCH via the RRC configuration, if the RRC-configured CG with the first SRI value is included in the RRC configuration and the UE is enabled for the updates to the PLRS identifier for the type 1 CG PUSCH and the type 2 CG PUSCH (e.g., “enablePL-RS-UpdateForPUSCH-SRS-and-type1CG”), when the MAC-CE updates the first PLRS identifier, the UE may apply the updated first PLRS identifier for the CG PUSCH.

### Example Method for Wireless Communications at a User Equipment (UE)

FIG. 7 shows an example of a method 700 for wireless communications at a user equipment (UE), such as the UE 104 of FIGS. 1 and 3.

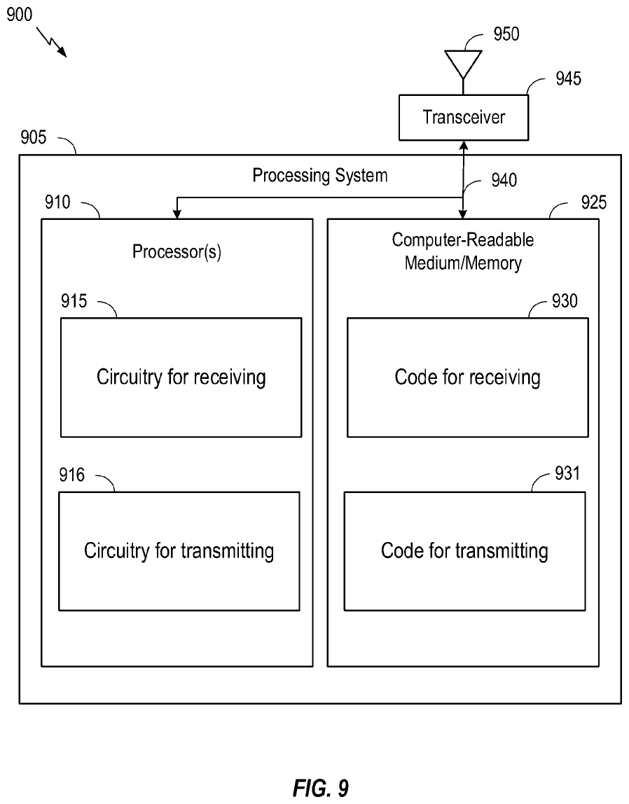

The method 700 begins at 705 with receiving first signaling that configures the UE with a configured grant (CG) of periodic transmission occasions, activates the CG, and indicates a path loss reference signal (PLRS) identifier associated with the CG. In some cases, the operations of this step refer to, or may be performed by, circuitry for receiving and/or code for receiving as described with reference to FIG. 9.

The method 700 then proceeds to 710 with receiving second signaling indicating an updated PLRS identifier associated with the CG. In some cases, the operations of this step refer to, or may be performed by, circuitry for receiving and/or code for receiving as described with reference to FIG. 9.

The method 700 then proceeds to 715 with transmitting an uplink transmission in a transmission occasion of the CG, with transmission power determined in accordance with the updated PLRS identifier. In some cases, the operations of this step refer to, or may be performed by, circuitry for transmitting and/or code for transmitting as described with reference to FIG. 9.

In certain aspects, the uplink transmission includes a physical uplink shared channel (PUSCHI) transmission.

In certain aspects, the first signaling includes radio resource control (RRC) signaling.

In certain aspects, the second signaling includes a medium access control (MAC) control element (CE).

In certain aspects, the method 700 further includes transmitting an indication of a capability of the UE to support updates to the PLRS identifier associated with the CG In certain aspects, the first signaling indicates updates to the PLRS identifier associated with the CG are enabled.

In certain aspects, the first signaling carries a flag to indicate that the updates to the PLRS identifier associated with the CG are enabled.

In certain aspects, the method 700 further includes receiving third signaling carrying a flag to indicate that the updates to the PLRS identifier for CGs are enabled.

In certain aspects, the third signaling includes RRC signaling.

In one aspect, the method 700, or any aspect related to it, may be performed by an apparatus, such as a communications device 900 of FIG. 9, which includes various components operable, configured, or adapted to perform the method 700. The communications device 900 is described below in further detail.

Note that FIG. 7 is just one example of a method, and other methods including fewer, additional, or alternative steps are possible consistent with this disclosure.

### Example Method for Wireless Communications at a Network Entity

FIG. 8 shows an example of a method 800 for wireless communications at a network entity, such as a base station (BS) 102 of FIGS. 1 and 3, or a disaggregated BS as discussed with respect to FIG. 2.

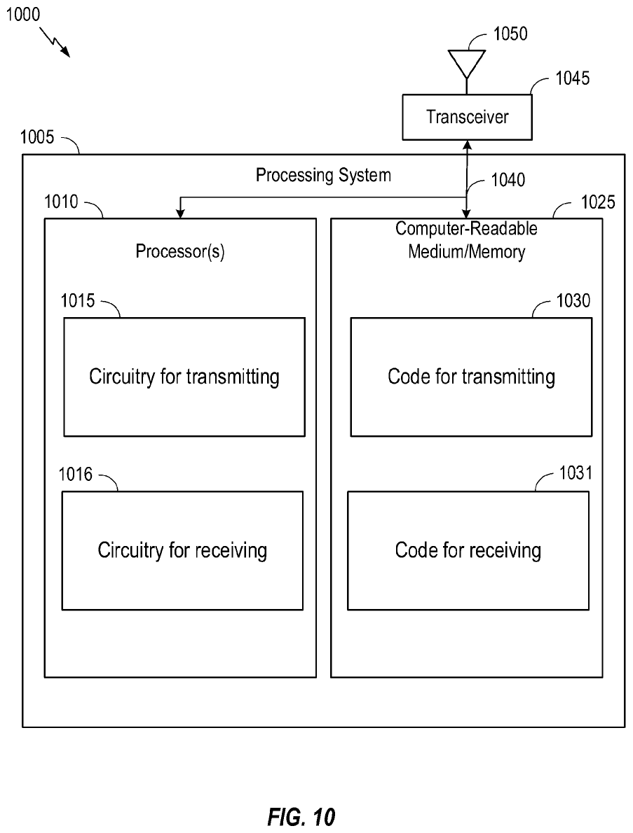

The method 800 begins at 805 with transmitting first signaling configuring a user equipment (UE) with a configured grant (CG) of periodic transmission occasions, activating the CG, and indicating a path loss reference signal (PLRS) identifier associated with the CG. In some cases, the operations of this step refer to, or may be performed by, circuitry for transmitting and/or code for transmitting as described with reference to FIG. 10.

The method 800 then proceeds to 810 with transmitting second signaling indicating an updated PLRS identifier associated with the CG. In some cases, the operations of this step refer to, or may be performed by, circuitry for transmitting and/or code for transmitting as described with reference to FIG. 10.

The method 800 then proceeds to 815 with receiving an uplink transmission in a transmission occasion of the CG, with transmission power determined in accordance with the updated PLRS identifier. In some cases, the operations of this step refer to, or may be performed by, circuitry for receiving and/or code for receiving as described with reference to FIG. 10.

In certain aspects, the uplink transmission includes a physical uplink shared channel (PUSCH) transmission.

In certain aspects, the first signaling includes radio resource control (RRC) signaling.

In certain aspects, the second signaling includes a medium access control (MAC) control element (CE).

In certain aspects, the method 800 further includes receiving an indication of a capability of the UE to support updates to the PLRS identifier associated with the CG.

In certain aspects, the first signaling indicates updates to the PLRS identifier associated with the CG are enabled.

In certain aspects, the first signaling carries a flag to indicate that the updates to the PLRS identifier associated with the CG are enabled.

In certain aspects, the method 800 further includes transmitting third signaling carrying a flag to indicate that the updates to the PLRS identifier for CGs are enabled.

In certain aspects, the third signaling includes RRC signaling.

In one aspect, the method 800, or any aspect related to it, may be performed by an apparatus, such as a communications device 1000 of FIG. 10, which includes various components operable, configured, or adapted to perform the method 800. The communications device 1000 is described below in further detail.

Note that FIG. 8 is just one example of a method, and other methods including fewer, additional, or alternative steps are possible consistent with this disclosure.

### Example Communications Devices

FIG. 9 depicts aspects of an example communications device 900. In some aspects, communications device 900 is a user equipment (UE), such as UE 104 described above with respect to FIGS. 1 and 3.

The communications device 900 includes a processing system 905 coupled to a transceiver 945 (e.g., a transmitter and/or a receiver). The transceiver 945 is configured to transmit and receive signals for the communications device 900 via an antenna 950, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 925 via a bus 940. In certain aspects, the computer-readable medium/memory 925 is configured to store instructions (e.g., computer-executable code) that when executed by the one or more processors 910, cause the one or more processors 910 to perform the method 700 described with respect to FIG. 7. Note that reference to a processor performing a function of communications device 900 may include one or more processors 910 performing that function of communications device 900.

In the depicted example, computer-readable medium/memory 925 stores code (e.g., executable instructions), such as code for receiving 930 and code for transmitting 931. Processing of the code for receiving 930 and the code for transmitting 931 may cause the communications device 900 to perform the method 700 described with respect to FIG. 7.

The one or more processors 910 include circuitry configured to implement (e.g., execute) the code stored in the computer-readable medium/memory 925, including circuitry such as circuitry for receiving 915 and circuitry for transmitting 916. Processing with the circuitry for receiving 915 and the circuitry for transmitting 916 may cause the communications device 900 to perform the method 700 described with respect to FIG. 7.

Various components of the communications device 900 may provide means for performing the method 700 described with respect to FIG. 7 and/or any aspect related to it. For example, means for transmitting, sending or outputting for transmission may include transceivers 354 and/or antenna(s) 352 of the UE 104 illustrated in FIG. 3 (and/or the circuitry for transmitting 916, the code for transmitting 931, the transceiver 945 and the antenna 950 of the communications device 900 in FIG. 9). Means for receiving or obtaining may include transceivers 354 and/or antenna(s) 352 of the UE 104 illustrated in FIG. 3 (and/or the circuitry for receiving 915, the code for receiving 930, the transceiver 945 and the antenna 950 of the communications device 900 in FIG. 9).

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 9 is an example, and many other examples and configurations of communication device 900 are possible.

FIG. 10 depicts aspects of an example communications device 1000. In some aspects, communications device 1000 is a network entity, such as BS 102 of FIGS. 1 and 3, or a disaggregated base station as discussed with respect to FIG. 2.

The communications device 1000 includes a processing system 1005 coupled to the transceiver 1045 (e.g., a transmitter and/or a receiver) and/or a network interface 4. The transceiver 1045 is configured to transmit and receive signals for the communications device 1000 via the antenna 1050, such as the various signals as described herein. The network interface is configured to obtain and send signals for the communications device 1000 via communication link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code) that when executed by the one or more processors 1010, cause the one or more processors 1010 to perform the method 800 described with respect to FIG. 8 or any aspect related to it. Note that reference to a processor of communications device 1000 performing a function may include one or more processors 1010 of communications device 1000 performing that function.

In the depicted example, the computer-readable medium/memory 1025 stores code (e.g., executable instructions), such as code for transmitting 1030 and code for receiving 1031. Processing of the code for transmitting 1030 and the code for receiving 1031 may cause the communications device 1000 to perform the method 800 described with respect to FIG. 8 or any aspect related to it.

The one or more processors 1010 include circuitry configured to implement (e.g., execute) the code stored in the computer-readable medium/memory 1025, including circuitry such as circuitry for transmitting 1015 and circuitry for receiving 1016. Processing with the circuitry for transmitting 1015 and the circuitry for receiving 1016 may cause the communications device 1000 to perform the method 800 described with respect to FIG. 8 or any aspect related to it.

Various components of the communications device 1000 may provide means for performing the method 800 described with respect to FIG. 8 or any aspect related to it. Means for transmitting, sending or outputting for transmission may include transceivers 332 and/or antenna(s) 334 of the BS 102 illustrated in FIG. 3 (and/or the circuitry for transmitting 1015, the code for transmitting 1030, the transceiver 1045 and the antenna 1050 of the communications device 1000 in FIG. 10). Means for receiving or obtaining may include transceivers 332 and/or antenna(s) 334 of the BS 102 illustrated in FIG. 3 (and/or the circuitry for receiving 1016, the code for receiving 1031, the transceiver 1045 and the antenna 1050 of the communications device 1000 in FIG. 10).

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 10 is an example, and many other examples and configurations of communication device 1000 are possible.

### Example Clauses

Implementation examples are described in the following numbered clauses:

Clause 1: A method for wireless communications at a user equipment (UE), comprising: receiving first signaling that configures the UE with a configured grant (CG) of periodic transmission occasions, activates the CG, and indicates a path loss reference signal (PLRS) identifier associated with the CG; receiving second signaling indicating an updated PLRS identifier associated with the CG; and transmitting an uplink transmission in a transmission occasion of the CG, with transmission power determined in accordance with the updated PLRS identifier.

Clause 2: The method of clause 1, wherein the uplink transmission comprises a physical uplink shared channel (PUSCH) transmission.

Clause 3: The method of any one of clauses 1-2, wherein the first signaling comprises radio resource control (RRC) signaling.

Clause 4: The method of any one of clauses 1-3, wherein the second signaling comprises a medium access control (MAC) control element (CE).

Clause 5: The method of any one of clauses 1-4, further comprising transmitting an indication of a capability of the UE to support updates to the PLRS identifier associated with the CG.

Clause 6: The method of any one of clauses 1-5, wherein the first signaling indicates updates to the PLRS identifier associated with the CG are enabled.

Clause 7: The method of clause 6, wherein the first signaling carries a flag to indicate that the updates to the PLRS identifier associated with the CG are enabled.

Clause 8: The method of any one of clauses 1-7, further comprising receiving third signaling carrying a flag to indicate that the updates to the PLRS identifier for CGs are enabled.

Clause 9: The method of clause 8, wherein the third signaling comprises radio resource control (RRC) signaling.

Clause 10: A method for wireless communications at a network entity, comprising: transmitting first signaling configuring a user equipment (UE) with a configured grant (CG) of periodic transmission occasions, activating the CG, and indicating a path loss reference signal (PLRS) identifier associated with the CG; transmitting second signaling indicating an updated PLRS identifier associated with the CG; and receiving an uplink transmission in a transmission occasion of the CG, with transmission power determined in accordance with the updated PLRS identifier.

Clause 11: The method of clause 10, wherein the uplink transmission comprises a physical uplink shared channel (PUSCH) transmission.

Clause 12: The method of any one of clauses 10-11, wherein the first signaling comprises radio resource control (RRC) signaling.

Clause 13: The method of any one of clauses 10-12, wherein the second signaling comprises a medium access control (MAC) control element (CE).

Clause 14: The method of any one of clauses 10-13, further comprising receiving an indication of a capability of the UE to support updates to the PLRS identifier associated with the CG.

Clause 15: The method of any one of clauses 10-14, wherein the first signaling indicates updates to the PLRS identifier associated with the CG are enabled.

Clause 16: The method of clause 15, wherein the first signaling carries a flag to indicate that the updates to the PLRS identifier associated with the CG are enabled.

Clause 17: The method of any one of clauses 10-16, further comprising transmitting third signaling carrying a flag to indicate that the updates to the PLRS identifier for CGs are enabled.

Clause 18: The method of clause 17, wherein the third signaling comprises radio resource control (RRC) signaling.

Clause 19: An apparatus, comprising: a memory comprising executable instructions; and a processor configured to execute the executable instructions and cause the apparatus to perform a method in accordance with any one of Clauses 1-18.

Clause 20: An apparatus, comprising means for performing a method in accordance with any one of Clauses 1-18.

Clause 21: A non-transitory computer-readable medium comprising executable instructions that, when executed by a processor of an apparatus, cause the apparatus to perform a method in accordance with any one of Clauses 1-18.

Clause 22: A computer program product embodied on a computer-readable storage medium comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
a memory comprising instructions; and
a processor configured to execute the instructions and cause the apparatus to:
receive first signaling that configures the UE with a configured grant (CG) of periodic transmission occasions, activates the CG, and indicates a path loss reference signal (PLRS) identifier associated with the CG;
receive second signaling indicating an updated PLRS identifier associated with the CG; and
transmit an uplink transmission in a transmission occasion of the CG, with transmission power determined in accordance with the updated PLRS identifier.

2. The apparatus of claim 1, wherein the uplink transmission comprises a physical uplink shared channel (PUSCH) transmission.

3. The apparatus of claim 1, wherein the first signaling comprises radio resource control (RRC) signaling.

4. The apparatus of claim 1, wherein the second signaling comprises a medium access control (MAC) control element (CE).

5. The apparatus of claim 1, wherein the processor is further configured to execute the instructions and cause the apparatus to transmit an indication of a capability of the UE to support updates to the PLRS identifier associated with the CG.

6. The apparatus of claim 1, wherein the first signaling indicates updates to the PLRS identifier associated with the CG are enabled.

7. The apparatus of claim 6, wherein the first signaling carries a flag to indicate that the updates to the PLRS identifier associated with the CG are enabled.

8. The apparatus of claim 1, wherein the processor is further configured to execute the instructions and cause the apparatus to receive third signaling carrying a flag to indicate that the updates to the PLRS identifier for CGs are enabled.

9. The apparatus of claim 8, wherein the third signaling comprises radio resource control (RRC) signaling.

10. An apparatus for wireless communications at a network entity, comprising:
a memory comprising instructions; and
a processor configured to execute the instructions and cause the apparatus to:
transmit first signaling configuring a user equipment (UE) with a configured grant (CG) of periodic transmission occasions, activating the CG, and indicating a path loss reference signal (PLRS) identifier associated with the CG;
transmit second signaling indicating an updated PLRS identifier associated with the CG; and
receive an uplink transmission in a transmission occasion of the CG, with transmission power determined in accordance with the updated PLRS identifier.

11. The apparatus of claim 10, wherein the uplink transmission comprises a physical uplink shared channel (PUSCH) transmission.

12. The apparatus of claim 10, wherein the first signaling comprises radio resource control (RRC) signaling.

13. The apparatus of claim 10, wherein the second signaling comprises a medium access control (MAC) control element (CE).

14. The apparatus of claim 10, wherein the processor is further configured to execute the instructions and cause the apparatus to receive an indication of a capability of the UE to support updates to the PLRS identifier associated with the CG.

15. The apparatus of claim 10, wherein the first signaling indicates updates to the PLRS identifier associated with the CG are enabled.

16. The apparatus of claim 15, wherein the first signaling carries a flag to indicate that the updates to the PLRS identifier associated with the CG are enabled.

17. The apparatus of claim 10, wherein the processor is further configured to execute the instructions and cause the apparatus to transmit third signaling carrying a flag to indicate that the updates to the PLRS identifier for CGs are enabled.

18. The apparatus of claim 17, wherein the third signaling comprises radio resource control (RRC) signaling.

19. A method for wireless communications at a user equipment (UE), comprising:
receiving first signaling that configures the UE with a configured grant (CG) of periodic transmission occasions, activates the CG, and indicates a path loss reference signal (PLRS) identifier associated with the CG;
receiving second signaling indicating an updated PLRS identifier associated with the CG; and
transmitting an uplink transmission in a transmission occasion of the CG, with transmission power determined in accordance with the updated PLRS identifier.

20. The method of claim 19, wherein the uplink transmission comprises a physical uplink shared channel (PUSCH) transmission.

21-30. (canceled)
